(19) United States
(12) Patent Application Publication
(10) Pub. No.: US 2006/0268716 A1
(43) Pub. Date: Nov. 30, 2006

(54) Traffic prioritization techniques for wireless networks

(76) Inventors: Carl S. Wijting, Helsinki (FI); Jarkko Kneckt, Espoo (FI)

Correspondence Address: BRAKE HUGHES PLC;c/o PORTFOLIOIP, c/o PORTFOLIOIP, P.O. BOX 52050, MINNEAPOLIS, MN, 55402, US

(21) Appl. No.: 11/440,374

(22) Filed: May 24, 2006

Related U.S. Application Data
(60) Provisional application No. 60/684,935, filed on May 26, 2005.

(51) Int. Cl. H04J 1/16; H04L 12/56

(52) U.S. Cl. 370/235; 370/408

(57) ABSTRACT

Various embodiments are disclosed relating to traffic prioritization techniques for wireless networks. In an example embodiment, different priorities may be applied to uplink traffic and downlink traffic at one or more nodes or mesh points in a wireless network, such as within a wireless meshed network, for at least some traffic. In another example embodiment, a first set of QoS parameters may be used for uplink traffic while a second set of QoS parameters may be used for downlink traffic for one or more nodes within a wireless network, for at least some traffic. According to another example embodiment, local or intra-cell traffic may be prioritized differently than inter-cell traffic for a mesh point within a wireless meshed network, for at least some traffic. For example, local or intra-cell traffic may be prioritized over inter-cell traffic for a mesh point within a wireless meshed network.

### CROSS-REFERENCE TO RELATED APPLICATIONS

This application claims priority to U.S. Provisional application Ser. No. 60/684,935, filed on May 26, 2005, entitled “QoS Parameter Delivery Mechanism for Meshed Wireless Networks,” hereby incorporated by reference.

### BACKGROUND

The rapid diffusion of Wireless Local Area Network (WLAN) access and the increasing demand for WLAN coverage is driving the installation of a very large number of Access Points (AP). However, most wireless networks today offer little or no Quality of Service (QoS). While QoS may refer to many different concepts, QoS may, for example, include providing different levels or qualities of service for different types of traffic. A draft specification from the IEEE 802.11e Task Group has proposed a set of QoS parameters to be used for traffic between an Access Point and a station. See, e.g., Tim Godfrey, “Inside 802.11e: Making QoS A Reality Over WLAN Connections,” CommsDesign, Dec. 19, 2003.

The concept of a wireless meshed network of APs or other wireless nodes is also being considered. A wireless meshed network may be considered to be a collection of mesh points (MPs) interconnected with wireless links. Each MP may typically be an Access Point, but may also be a station or other wireless node. In some cases, the IEEE 802.11e proposal for QoS may not adequately address the needs and complexities of some wireless networks.

### SUMMARY

According to an example embodiment, different sets of QoS parameters and/or different sets of transmit queues may be applied to different aspects of a wireless network, such as a wireless meshed network. In one embodiment, a mesh point or other wireless node may use a first set of QoS parameters for a first type of traffic the network, and may use a second set of QoS parameters for a second type of traffic in the network.

In an example embodiment, a method may be provided. According to the method, different priorities may be applied to uplink traffic and downlink traffic for one or more nodes or mesh points within a network, such as within a wireless meshed network. For example, a first set of QoS parameters (such as EDCA parameters or other parameters) may be used for uplink traffic for one or more mesh points in a wireless meshed network, and a second set of QoS parameters may be used for downlink traffic for the one or more mesh points in the wireless meshed network. The QoS parameters may include one or more Access Category (AC) specific parameters. In another example embodiment, different transmission or transmit queues may be used for uplink and downlink traffic from a node or mesh point.

As noted, in an example embodiment, different priorities may be applied to uplink traffic and downlink traffic. In an example embodiment, uplink and downlink may be based upon, for example, a hierarchical relationship or relative location between nodes, e.g., mesh points (MPs) typically being located closer to (or even connected to) an external network and wireless stations typically located farther away from an external network (as compared to MPs), for example. Uplink traffic may include, for example, traffic directed toward an external network or toward a MP, such as station-to-MP (mesh point) traffic. While downlink traffic, for example, may include traffic traveling or directed away from an external network and/or directed toward a wireless station, such as MP-to-station traffic. In an example embodiment, MP-to-MP traffic may either be uplink traffic or downlink traffic, depending on the relative locations of the two MPs (e.g., based on which MP is closer to the network or to the wireless station).

In another example embodiment, local or intra-cell traffic may be prioritized over (or given a higher priority as compared to) inter-cell traffic for a mesh point within a wireless meshed network. For example, a first set of QoS parameters may be used for local or intra-cell traffic for a mesh point within a wireless meshed network, and a second set of QoS parameters may be used for inter-cell traffic for the mesh point within the wireless meshed network. In an alternative embodiment, or in addition, a first set of transmission queues may be used for local traffic, while a second set of transmission queues may be used for inter-cell traffic, for example.

In yet another example embodiment, a first set of QoS parameters may be used for MP-to-MP traffic, while a second set of QoS parameters may be used for MP-Station traffic. In another embodiment, a first set of QoS parameters may be used for MP-to-MP traffic in the uplink direction and a second set of QoS parameters for the downlink direction. While a third and a fourth sets of QoS parameters may be used for MP-to-Station (downlink) and Station-to-MP (uplink), respectively. In addition, one set of transmit queues may be used at each station or MP. Alternatively, a first set of transmit queues may be used at a MP for MP-to-MP traffic and a second set of transmit queues for MP-station traffic.

In another example embodiment, an apparatus may be provided, including a controller, a memory coupled to the controller, and a wireless transceiver coupled to the controller. The apparatus or controller may be configured or adapted to use a first set of QoS parameters for uplink traffic in a wireless meshed network, and to use a second set of QoS parameters for downlink traffic in the wireless meshed network. The apparatus may be provided at a wireless node or a mesh point, for example.

In yet another example embodiment, an apparatus may be provided, including a controller, a memory coupled to the controller, and a wireless transceiver coupled to the controller. The apparatus or controller may be configured or adapted to use a first set of QoS parameters for local or intra-cell traffic for a mesh point within a wireless meshed network, and to use a second set of QoS parameters for inter-cell traffic for a mesh point within a wireless meshed network.

According to yet another example embodiment, a meshed wireless distribution system may be provided, including one or more wireless mesh points. One or more of the mesh points may be configured or adapted to use a first set of QoS parameters for a first type of traffic in the network and a second set of QoS parameters for a second type of traffic in the network.

These are merely a few examples, and the disclosure is not limited thereto.

### BRIEF DESCRIPTION OF THE DRAWINGS

FIG. 1 is a diagram illustrating a wireless meshed network according to an example embodiment.

FIG. 2 is a block diagram of an example queue architecture that may be used in a Mesh Point or other wireless node according to an example embodiment.

FIG. 3 is a block diagram of input/output interfaces for a Mesh Point or other wireless node according to an example embodiment.

FIG. 4 is a flow chart illustrating operation of a wireless node according to an example embodiment.

FIG. 5 is a flow chart illustrating operation of a wireless node according to another example embodiment.

FIG. 6 is a flow chart illustrating operation of a wireless node according to yet another example embodiment.

FIG. 7 is a block diagram illustrating an example apparatus that may be provided in a wireless node according to an example embodiment.

### DETAILED DESCRIPTION

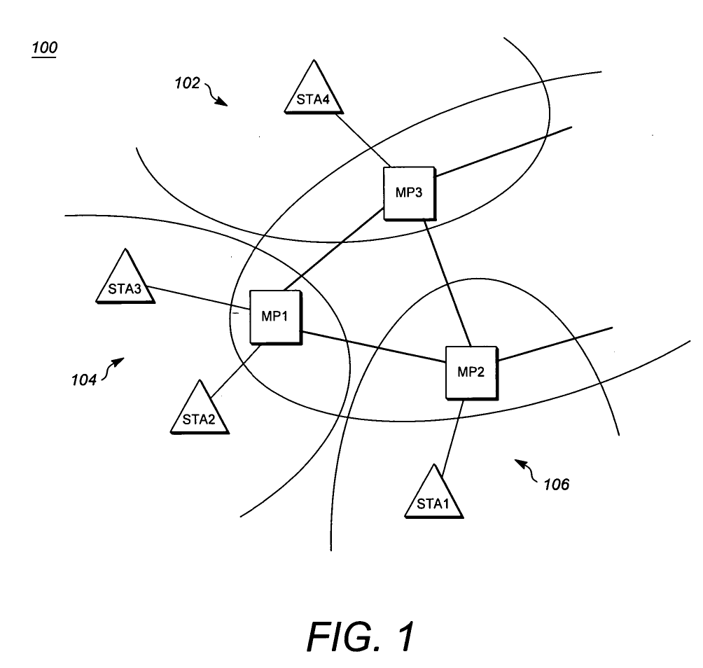

Referring to the Figures in which like numerals indicate like elements, FIG. 1 is a diagram illustrating a wireless meshed network 100 according to an example embodiment.

According to an example embodiment, a wireless meshed network may be a collection of mesh points (MPs) interconnected with wireless links. Each MP may typically be an Access Point, but may also be a station or other wireless node. For example, a wireless meshed network may employ either a full mesh topology or a partial mesh topology. In a full mesh topology, each node (or mesh point) may be connected directly to each of the other MPs via a wireless link. In a partial mesh topology, the mesh points may be connected to some but not necessarily all of the other mesh points in the meshed network.

In the example wireless meshed network 100 illustrated in FIG. 1, mesh points MP1, MP2 and MP3 may be inter-connected via wired or wireless links. Also, each mesh point (MP) may be coupled to one or more wireless stations in its local cell. For example, MP1 is located in cell 104 and is connected via wireless links to stations STA2 and STA3 within cell 104. MP2 is located in cell 106 and is connected via wireless link to stations STA1. MP3 is located in cell 102 and may be connected via wireless link to station STA4. Network 100 (including MP1, MP2 and MP3) may be considered a wireless distribution system. Wireless meshed network 100 is merely an example network and the disclosure is not limited thereto.

In an example wireless meshed network, each MP may be capable of many-to-many connections, and may be capable of learning network topology, dynamic path configuration, and other network capabilities, although the disclosure is not limited thereto. Each MP may also be mobile or be capable of being moved or movable, and may be capable of dynamically reconfiguring itself, although the disclosure is not limited thereto.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point (MP), or any other wireless device. These are merely a few examples of the wireless devices and technologies that may be used to implement the various embodiments described herein, and this disclosure is not limited thereto.

According to an example embodiment, different sets of QoS parameters and/or different sets of transmit queues may be applied to different aspects of a wireless network (such as a wireless meshed network) for channel access and data transmission. In an example embodiment, the QoS parameters used in the wireless meshed network may be similar to or even the same as the QoS parameters for Enhanced Distributed Channel Access (EDCA) included in the draft specification for the IEEE 802.11e (referred to herein as the EDCA parameters), although the disclosure is not limited thereto. The EDCA parameters are merely one example of a set of QoS parameters and many other types of QoS parameters may be used.

In an example embodiment, an EDCA contention access mechanism may use EDCA (QoS) parameters that allow for prioritization of traffic. For example, EDCA parameters such as the contention window and backoff time may be adjusted to change the probability of gaining medium access to favor higher priority classes of traffic. In an example embodiment, eight user priority levels may be available, although any number can be chosen.

TABLE 1

| | Access Category | |
|---|---|---|
| User Priority (UP) | (AC) | Designation |
| 2 | 0 | Best Effort |
| 1 | 0 | Best Effort |
| 0 | 0 | Best Effort |
| 3 | 1 | Video Probe |
| 4 | 2 | Video |
| 5 | 2 | Video |
| 6 | 3 | Voice |
| 7 | 3 | Voice |

Table 1 illustrates an example of how eight user priority (UP) levels may be mapped to four access categories (ACs). This is merely one example, and the disclosure is not limited thereto. Many other mappings or relationships between UP levels and ACs may be used. In this example, higher priority traffic may map to a higher AC.

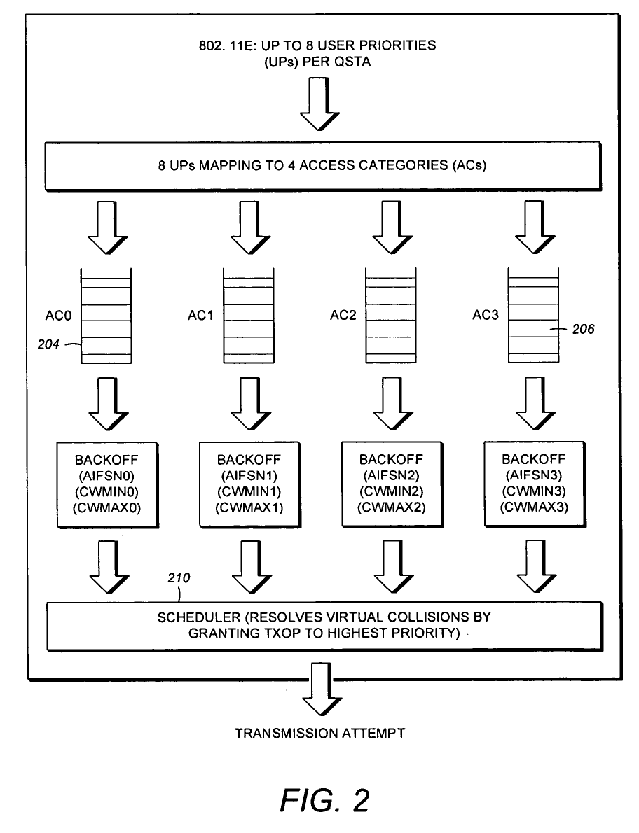

FIG. 2 is a block diagram of an example queue architecture that may be used in a Mesh Point or other wireless node according to an example embodiment. Each user priority (UP) may be mapped to an access category, such as AC0, AC1, AC2, AC3. As shown in FIG. 2, each AC may correspond to one of four transmit queues. For example, as shown in FIG. 2, AC0 may correspond to transmit queue 204, while AC3 may correspond to transmit queue 206, etc. In an example embodiment, each transmit queue may provide frames to an independent channel access function, each of which may implement a channel access function. When frames are available in multiple transmit queues, a scheduler 210 resolves these (virtual) collisions between frames from different queues by granting the transmission opportunity (TXOP) to the highest priority.

In this example embodiment shown in FIG. 2, a set of QoS parameters is provided for channel access and includes specific parameters for each AC. According to an example embodiment, these QoS parameters may include: CWmin[AC], which is the minimum contention window for the AC, the CWmax[AC], the AIFSN[AC] which is the arbitration inter-frame spacing for the AC, the TXOPLimit[AC] which defines the length of the TXOP a wireless node is granted, MSDULifetime[AC] which defines the maximum time the MSDU or its fragments are tried to deliver to the recipient, and the ACM bit[AC] which indicates whether access control is mandatory for the specified AC. Another QoS parameter may also be included, the GrantedMediumlifetime[AC], which indicates the granted lifetime for a medium access for the wireless node using specific AC. Therefore, once the admission control is used for a specific AC, which can be indicated e.g. using the ACM bit[AC], the GrantedMediumlifetime[AC] parameter defines the maximum amount of time for an AC which is applied admission control to. The parameter, therefore, enables the control of the amount of time consumed by a certain AC traffic from the resources of the MP and the wireless medium.

As noted, these QoS parameters may be defined per AC. For example, as part of this set of QoS parameters, AC1 includes the parameters AIFSN1, CWmin1, CWmax1, and AC2 includes the parameters AIFSN2, CWmin2, CWmax2, etc. The QoS parameters may be set up to favor higher priority frames, e.g., to favor or give priority to frames in higher ACs. These are just some example QoS parameters, and the disclosure is not limited thereto.

According to an example embodiment, the QoS parameters may be stored at each MP or Station. MPs or Access Points may transmit the QoS parameters to other MPs or stations as part of their beacon. In an example embodiment, a beacon message may be a management or control message transmitted by a mesh point that provides information about the transmitting MP and/or enables other wireless stations or MPs to establish communications with the MP, although the disclosure is not limited thereto. Also, the QoS parameters may also be sent in Probe (or Association) messages and in Re-Association messages through which a MP or station establishes communication with a MP.

In an example embodiment, admission control may be used at a MP (and possibly at stations) to regulate the amount of (e.g., high priority) data or nodes contending for the medium. In an example embodiment, admission control may be negotiated by the use of a TSPEC traffic specification which a station or MP provides to a MP to specify its traffic flow requirements (e.g., data rate, delay bounds, packet size). Based on the existing load, the MP may accept or deny the TSPEC request. If the TSPEC request is denied, the requesting station may not typically be permitted to transmit frames using the high AC (and associated high priority QoS parameters), but it may use lower priority parameters instead, such as for best effort traffic.

According to an example embodiment, different sets of QoS parameters and/or different sets of transmit queues may be applied to different aspects of a wireless network such as a wireless meshed network. These QoS parameters may be exchanged between MPs when a new MP joins the network or associates with an existing MP, for example through Association or Reassociation messages. The QoS parameters may also be transmitted when a station associates or re-associates with a MP. In an example embodiment, if no QoS parameters are provided, the MPs or wireless nodes may use a set of default QoS parameters.

In an example embodiment, a group of MPs in a wireless meshed network (or alternatively, all MPs in the network) may use the same set of QoS parameters. For example, if a plurality of MPs in a meshed wireless network use the same (or a common) set or sets of QoS parameters, this may provide the same quality of service for each Access Category (AC) throughout the whole network or at least throughout the portion of the network where the MPs are using a common set or sets of QoS parameters. For example, AC-specific performance may be provided (or in some cases possibly even guaranteed) throughout a mesh network where the MPs in the mesh network use the same (or a common) set(s) of QoS parameters.

For example, in a first embodiment, four (or up to four) sets of QoS parameters may be used. In this example embodiment, a first set of QoS parameters may be used for MP-to-MP traffic in the uplink direction and a second set of QoS parameters for MP-to-MP traffic in the downlink direction. A third set of QoS parameters may be used for MP-to-Station traffic (downlink) and a fourth set of QoS parameters may be used for Station-to-MP traffic (uplink). This embodiment that uses four different sets of QoS parameters offers full flexibility to differentiate the different traffic flows. A differentiation between uplink (UL) and downlink (DL) for MP-to-MP traffic may be used for example with a hierarchical organization of the MPs, or in combination with a depth parameter (e.g., number of hops removed from a certain MP). Otherwise, the UL and DL parameters for MP-to-MP could be made equal. The UL and DL parameters for MP-station traffic may arise out the situation of the one-to-many and many-to-one which happens in that case.

In a second example embodiment, a first set of QoS parameters may be used for all uplink traffic and a second set of QoS parameters may be used for all downlink traffic, regardless whether the traffic is MP-MP traffic or station-MP traffic. Therefore, the first set of QoS parameters may be for station-to-MP traffic (which is UL) and MP-to-MP in the UL direction, where the second set of QoS parameters may be used for MP-to-station traffic (which is DL) and MP-to-MP traffic in the DL direction.

In an example embodiment, uplink and downlink directions may be based on hierarchical arrangement or relationship between nodes. Fore example, some MPs may be connected to an external network, such as a LAN, a WAN, the Internet, etc. These MPs connected to an external network may be considered as root nodes. Traffic flowing toward or directed toward such root nodes (e.g., from stations or other MPs) may be considered uplink traffic, while traffic flowing away from root nodes (e.g., toward other MPs or toward wireless stations) may be considered downlink traffic. According to an example embodiment, uplink traffic may include station-to MP traffic, and downlink traffic may include MP-to-station traffic. MP-to-MP traffic may be either uplink or downlink, depending on, for example, the hierarchical relationship (or relative location) between the two MPs, e.g., depending on which MP is closer to the external network. These are merely some illustrative example embodiments, and the disclosure is not limited thereto.

According to a third embodiment, a first set of QoS parameters may be used for MP-to-MP traffic, which may be considered to be inter-cell traffic that is typically being forwarded between cells. A second set of QoS parameters may be used for MP-station traffic (both UL and DL). This would allow the network to prioritize local (in-cell) traffic over inter-cell (MP-MP) traffic. In addition, a third or separate set of QoS parameters may be used for direct-link traffic that is direct station-to-station traffic that does not pass through a MP or AP.

In a fourth example embodiment, two sets of QoS parameters may be used. As in the second embodiment, a first set of QoS parameters may be used for all uplink traffic and a second set of QoS parameters may be used for all downlink traffic, regardless whether the traffic is MP-MP traffic or station-MP. Having only two sets of QoS parameters may provide an advantage that the MP may only need to contend once for the transmission opportunity (TXOP). In addition, a first set of transmission queues may be used for MP-to-MP traffic and a second set of transmission queues may be used for MP-to-station traffic. The different queues may be used to provide a different service policy between MP-to-MP traffic and MP-to-station traffic. For example, during a TXOP, first all MP-to-station traffic could be sent and after that, the MP-to-MP traffic could be sent.

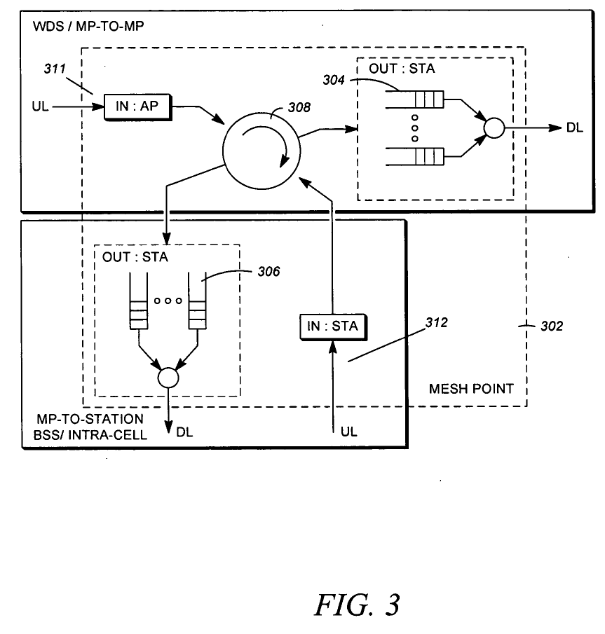

FIG. 3 is a block diagram of input/output interfaces for a Mesh Point (MP) according to an example embodiment. Mesh Point 302 may include a first set of transmission queues 306 for the transmission of frames to stations (DL traffic from the MP to a station). This MP-to-station traffic may also be referred to as in-cell or intra-cell traffic. A second set of transmission queues 304 is provided for the transmission of MP-to-MP frames. This MP-MP traffic may also be referred to as inter-cell traffic.

Referring to FIG. 3, frames from another MP may be received at point 311 and provided to a switch 308 for routing or switching to the appropriate output. If an incoming MP-to-MP frame is directed to another MP, then switch 308 will switch or direct the frame to be output via queues 304. Likewise, incoming frames from stations may be received at point 312 and provided to switch 308 for switching or routing to the appropriate location.

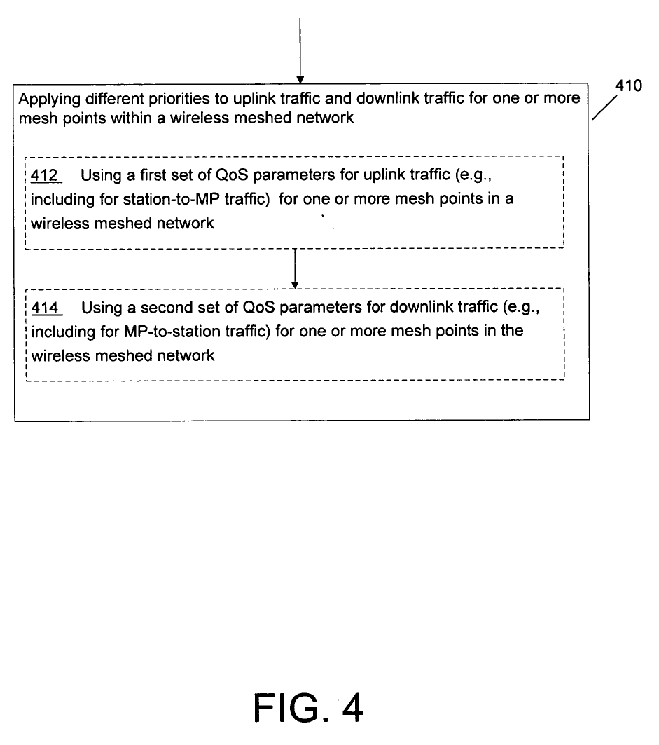

FIG. 4 is a flow chart illustrating operation of a wireless node according to an example embodiment. At 410, different priorities may be applied to uplink traffic and downlink traffic for one or more mesh points within a wireless meshed network, e.g., at least for some of the traffic. For example, a mesh point may prioritize downlink traffic over uplink traffic, or may prioritize uplink traffic over downlink traffic, for example.

Operation 410 in FIG. 4 may include operations 412 and/or 414. At operation 412, a first set of QoS (quality of service) parameters may be used for uplink traffic for one or more mesh points in a wireless meshed network. The uplink traffic may include, for example, station-to-MP traffic. At operation 414, a second set of QoS parameters may be used for downlink traffic for one or more mesh points in the wireless meshed network. The downlink traffic may include, for example, MP-to-station traffic.

By using different QoS parameters for uplink traffic and downlink traffic, different priorities may be applied to uplink traffic and downlink traffic. For example, EDCA parameters or QoS parameters for AC1 (access category 1) may be used for downlink traffic, while QoS parameters for AC2 may be used for uplink traffic, or vice versa. This is merely an example, and the disclosure is not limited thereto.

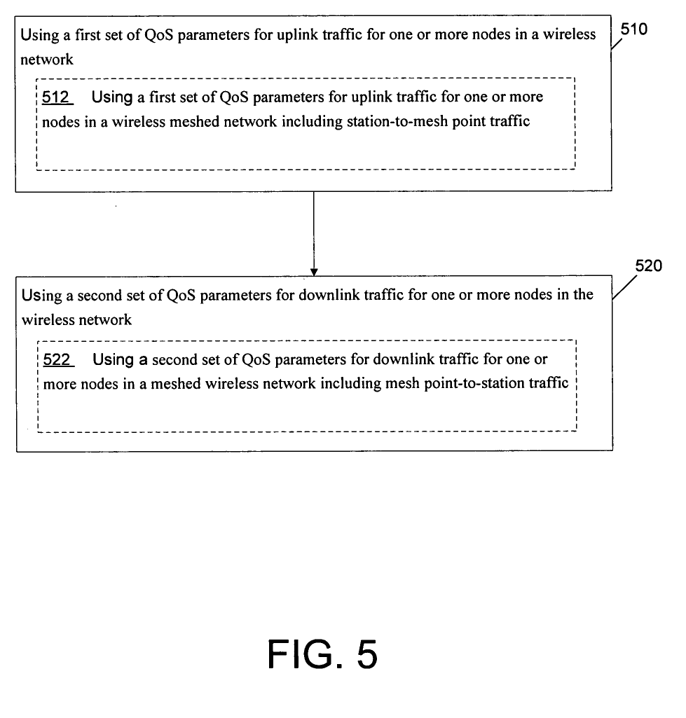

FIG. 5 is a flow chart illustrating operation of a wireless node according to another example embodiment. At 510, a first set of QoS parameters may be used for uplink traffic for one or more nodes in a wireless network, e.g., at least for some of the uplink traffic. Operation 510 may include operation 512, according to an example embodiment. At operation 512, a first set of QoS parameters may be used for uplink traffic for one or more nodes in a wireless meshed network including station-to-MP traffic.

At 520, a second set of QoS parameters may be used for downlink traffic for one or more nodes in the wireless network, at least for some of the downlink traffic. Operation 520 may include operation 522, according to an example embodiment. At operation 522, a second set of QoS parameters may be used for downlink traffic for one or more nodes in a wireless meshed network including MP-to-station traffic.

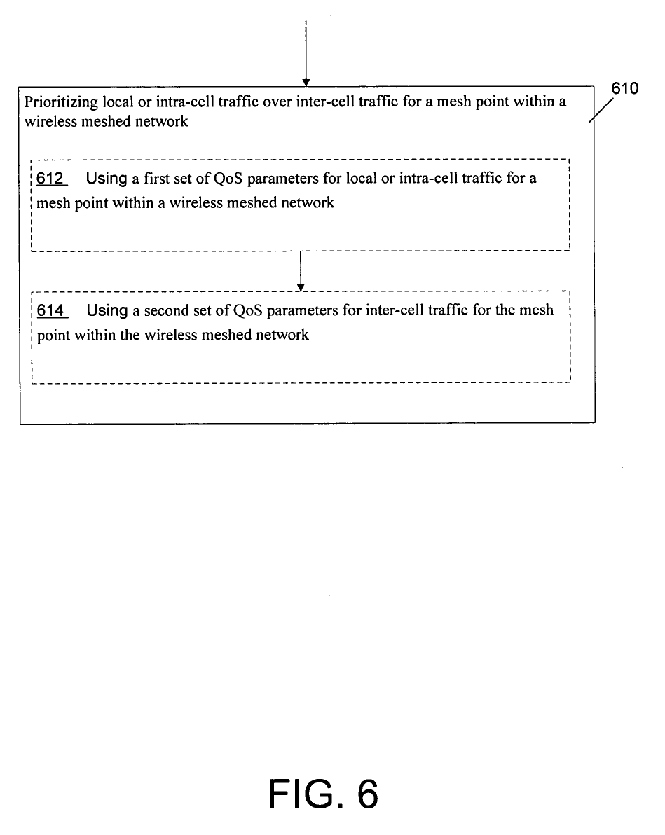

FIG. 6 is a flow chart illustrating operation of a wireless node according to yet another example embodiment. At 610, local or intra-cell traffic may be prioritized over inter-cell traffic for a mesh point within a wireless meshed network, e.g., at least for some of the traffic. Operation 610 may include operations 612 and/or 614 in an example embodiment. At 612, a first set of QoS parameters may be used for local or intra-cell traffic for a MP within a wireless meshed network, e.g., at least for some of the local traffic. At 614, a second set of QoS parameters may be used for inter-cell traffic for the mesh point within the wireless meshed network, at least for some of the inter-cell traffic.

In yet another example embodiment, three (or up to three) different sets of QoS parameter sets may be used as follows. A first set of parameters may be used for downlink traffic (e.g., MP-to-station traffic), and the downlink traffic may be given a higher priority or higher AC than uplink traffic, in an example embodiment. A second set of QoS parameters may be used for uplink traffic from stations. And, a third set of QoS parameters may be used for uplink traffic from mesh points or access points.

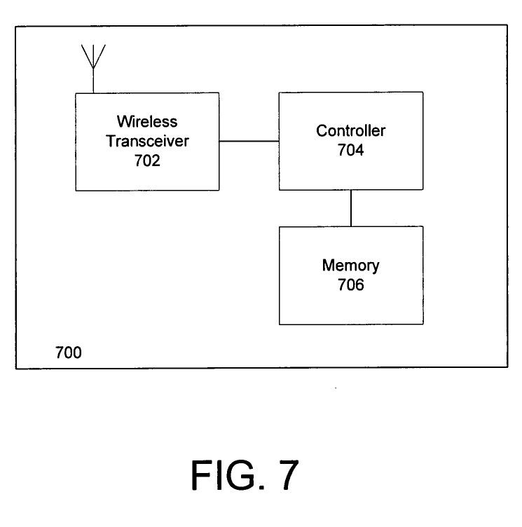

In an example embodiment, each wireless node or mesh point (MP) may include a wireless transceiver, a processor or controller, and memory. FIG. 7 is a block diagram illustrating an example apparatus 700 that may be provided in a wireless node according to an example embodiment. The wireless node, such as a station, AP, MP, etc., may include, for example, a wireless transceiver 702 to transmit and receive signals, a controller 704 to control operation of the station or node and execute instructions or software, and a memory 706 to store data and/or instructions.

Controller 704 may be programmable and capable of executing software or other instructions stored in memory or on other computer media to perform the various tasks and functions described above, such as one or more the tasks or methods described above in FIGS. 1-6.

In an example embodiment, the apparatus or controller 704 may be configured or adapted to apply different priorities to uplink traffic and downlink traffic. In another embodiment, controller 704 may be configured to use a first set of QoS parameters for uplink traffic in a wireless meshed network, and to use a second set of QoS parameters for downlink traffic in the wireless meshed network.

In yet another example embodiment, the controller 704 may be configured or adapted to prioritize local or intra-cell traffic differently than inter-cell traffic, such as by prioritizing local traffic over inter-cell traffic. In another example embodiment, the controller 704 may be configured to use a first set of QoS parameters for local or intra-cell traffic for a mesh point within a wireless meshed network, and to use a second set of QoS parameters for inter-cell traffic for a mesh point within a wireless meshed network.

According to yet another example embodiment, a meshed wireless distribution system may be provided, including one or more wireless mesh points. One or more of the mesh points may be configured or adapted to use a first set of QoS parameters for a first type of traffic in the network and a second set of QoS parameters for a second type of traffic in the network

In addition, a storage medium may be provided that includes stored instructions, when executed by a controller or processor (such as a mesh point processor) will result in the node or MP performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) or methods described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of some example embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments of the various embodiments.

What is claimed is:

1. A method comprising:
applying different priorities to uplink traffic and downlink traffic for one or more mesh points within a wireless meshed network.

2. The method of claim 1 wherein the applying comprises:
using a first set of QoS parameters for uplink traffic for one or more mesh points in a wireless meshed network; and
using a second set of QoS parameters for downlink traffic for one or more mesh points in the wireless meshed network.

3. The method of claim 1 wherein the applying comprises:
using a first set of QoS parameters for mesh point-to-mesh point traffic in an uplink direction;
using a second set of QoS parameters for mesh point-to-mesh point traffic in a downlink direction;
using a third set of QoS parameters for mesh point-to-station traffic; and using a
fourth set of QoS parameters for station-to-mesh point traffic.

4. A method comprising:
using a first set of QoS parameters for uplink traffic for one or more nodes in a wireless network; and
using a second set of QoS parameters for downlink traffic for one or more nodes in the wireless network.

5. The method of claim 4 wherein the using a first set of QoS parameters comprises using a first set of QoS parameters for uplink traffic for one or more mesh points in a wireless meshed network, and wherein using a second set of QoS parameters comprises using a second set of QoS parameters for downlink traffic for one or more mesh points in the wireless meshed network.

6. The method of claim 4 wherein said using a first set comprises using a first set of QoS parameters for uplink traffic for one or more nodes in a wireless meshed network including station-to-mesh point traffic;
and said using a second set comprises using a second set of QoS parameters for downlink traffic for one or more nodes in a meshed wireless network including mesh point-to-station traffic.

7. The method of claim 4 wherein said first and second sets of QoS parameters including one or more Access Category specific parameters.

8. The method of claim 4 wherein said first and second sets of QoS parameters include one or more Access Category-specific parameters, including one or more of: a minimum contention window size, a maximum contention window size, an arbitration inter-frame spacing value, a transmit opportunity limit, a MSDU Lifetime value, or a granted medium lifetime value.

9. A method comprising:
prioritizing local or intra-cell traffic over inter-cell traffic for a mesh point within a wireless meshed network.

10. The method of claim 9 wherein the prioritizing comprises:
using a first set of QoS parameters for local or intra-cell traffic for a mesh point within a wireless meshed network; and
using a second set of QoS parameters for inter-cell traffic for the mesh point within the wireless meshed network.

11. The method of claim 10 wherein said first and second sets of QoS parameters including one or more Access Category specific parameters.

12. The method of claim 9 wherein the prioritizing comprises:
using a first set of transmission queues for local or intra-cell traffic for a mesh point within a wireless meshed network; and
using a second set of transmission queues for inter-cell traffic for the mesh point within the wireless meshed network.

13. An apparatus comprising:
a controller;
a memory coupled to the controller; and
a wireless transceiver coupled to the controller;
the apparatus adapted to:
use a first set of QoS parameters for uplink traffic in a wireless meshed network; and
use a second set of QoS parameters for downlink traffic in the wireless meshed network.

14. The apparatus of claim 13, wherein the apparatus comprises a wireless mesh point.

15. An apparatus comprising:
a controller;
a memory coupled to the controller; and
a wireless transceiver coupled to the controller;
the apparatus adapted to:
use a first set of QoS parameters for local or intra-cell traffic within a wireless meshed network; and
use a second set of QoS parameters for inter-cell traffic within the wireless meshed network.

16. The apparatus of claim 15, wherein the apparatus comprises a wireless mesh point.

17. A meshed wireless distribution system comprising one or more wireless mesh points, one or more of the mesh points adapted to use a first set of QoS parameters for a first type of traffic in the network and a second set of QoS parameters for a second type of traffic in the network.

18. The meshed wireless distribution system of claim 17 wherein the one or more mesh points being adapted to:
use a first set of QoS parameters for uplink traffic in a wireless meshed network; and
use a second set of QoS parameters for downlink traffic in the wireless meshed network.

19. The meshed wireless distribution system of claim 17 wherein the one or more mesh points being adapted to:
use a first set of QoS parameters for local or intra-cell traffic within a wireless meshed network; and
use a second set of QoS parameters for inter-cell traffic within the wireless meshed network.

20. An article comprising:
a storage medium; said storage medium including stored thereon instructions that, when executed by a processor, result in:
using a first set of QoS parameters for uplink traffic in a wireless meshed network; and
using a second set of QoS parameters for downlink traffic in the wireless meshed network.
